(19) United States
(12) Patent Application Publication
(10) Pub. No.: US 2015/0172808 A1
(43) Pub. Date: Jun. 18, 2015

(54) Microphone and Accessory for Microphone

(71) Applicant: Hiroaki Furuya, Tokyo (JP)

(72) Inventor: Hiroaki Furuya, Tokyo (JP)

(73) Assignee: KABUSHIKI KAISHA AUDIO-TECHNICA, Tokyo (JP)

(21) Appl. No.: 14/560,170

(22) Filed: Dec. 4, 2014

(30) Foreign Application Priority Data
Dec. 17, 2013 (JP) 2013-260432

(51) Int. Cl. H04R 3/00; F21V 8/00

(52) U.S. Cl. CPC H04R 3/00; G02B 6/0051; G02B 6/0058

(57) ABSTRACT

A microphone includes a switch that turns on and off an audio signal; light sources that are turned on and off in response to the operation of the switch; a light-incident portion that receives light from the light sources; a light guide that directs the light in the longitudinal direction; and a light radiator having a light diffuser that diffuses light. The light guide has a thickness that decreases with the distance from the light-entering portions.

### BACKGROUND OF THE INVENTION

1. Technical Field

The present invention relates to a microphone and an accessory for a microphone that optically indicates the ON and OFF states of the output of audio signals generated through acousto-electric conversion.

2. Background Art

Boundary microphones are unobtrusively mounted on top panels of tables or desks in conference rooms and class rooms. There are two types of boundary microphones: one type is of a low profile (slim) and is placed on the top panel, and the other type is mostly embedded in the top panel with only the sound collector exposed.

FIG. 18 illustrates an example embeddable boundary microphone according to the related art. With reference to FIG. 18, the embeddable boundary microphone 80 includes a cylindrical microphone body 81. A microphone unit 82 is mounted at a first end of the microphone body 81. A cushioning 85 is disposed in the interior of the microphone body 81 near the first end. The cushioning 85 supports the microphone body 81. The microphone body 81 has a flange 86 on the outer circumference of the first end.

The most portion of the microphone body 81 is embedded in a top panel of, for example, a table or a desk. The microphone body 81 has the flange 86. The flange 86 is in contact with the circumference of a mounting hole formed in the top panel of the table or desk, causing only the upper end of the microphone body 81 to be exposed above the top panel. A metal mesh 83 is fixed to the flange 86. The metal mesh 83 covers the microphone unit 82. The microphone body 81 accommodates a circuit board 84 including a microphone circuit. Audio signals acousto-electrically converted at the microphone unit 82 are output to an external device via a microphone connector 88.

Gooseneck microphones are also used in conference rooms and class rooms. A gooseneck microphone includes a base portion that is to be fixed to a top panel of, for example, a table or desk, a flexible pipe attached to the base portion, and a microphone fixed to the distal end of the flexible pipe.

In a conference room or class room, multiple microphones, each having a switch for turning on and off the audio signal output, are installed for use by multiple attendants. If these multiple microphones are simultaneously turned on, multiple voices and/or noises are collected, resulting in indistinct sounds. To avoid this, only the switch of the microphone to be used by a speaker can be operated to turn on the microphone. Some microphones indicate the ON and OFF states of the switch with light. Such a microphone that indicates the ON and OFF states of the switch with light, for example, turns on a green light source in response to turning on the switch and turns on a red light source in response to turning off the switch.

A microphone that indicates the ON and OFF states of the switch with different light colors usually includes light indicators having multiple light sources of different colors and a light radiator. A light radiator is usually in the form of a ring surrounding the microphone. The light from the light sources disposed below the light radiator is directed to the surface of the light radiator. The light radiates from the surface of the light radiator. The light radiator has a large length along the center axis to uniformly diffuse the light from the light sources disposed below the light radiator and increase the internal light diffusion. This unfortunately increases the dimensions of the light indicator and the overall dimensions of the microphone that indicates the ON and OFF states of the switch with different light colors. To achieve uniform diffusion and sufficient intensity of the light, the light indicator has multiple light sources disposed in equal intervals at positions facing the light radiator. This increases the structural complexity of the microphone that indicates the ON and OFF states of the switch with different light colors and, thus increases material and production costs.

The related art associated with such a light radiator is described below.

Japanese Unexamined Patent Application Publication No. 2009-259580 discloses an input device that includes an illuminated indicator integrated with a light guide having branches and light sources disposed opposite to the distal ends of the branches. According to Japanese Unexamined Patent Application Publication No. 2009-259580, the branches may be aligned or misaligned with the light sources depending on the position of the indicator and cause the indicator to flicker to mark the position of the indicator.

Japanese Unexamined Patent Application Publication No. 2006-323615 discloses a light indicator that includes a display having a light-guiding path, a first end surface of the display facing a light emitter mounted on a printed circuit board, a second end surface radiating light from the first end surface of the display.

Japanese Unexamined Patent Application Publication No. H 10-207408 discloses a light-guiding unit and a display for a vehicle in which light from a light source enters a light-guiding path and annularly illuminates the periphery of the display. In Japanese Unexamined Patent Application Publication No. 10-207408, a light diffusion treatment is applied to a reflective surface for the transmission of light through the light-guiding path to achieve uniform annular illumination.

Japanese Unexamined Patent Application Publication No. 2004-288584 discloses a surface emitting apparatus that includes an annular light-guiding plate having an outer circumference integrated with an auxiliary light guide bidirectionally guiding light from a light source through the circumferential light path of the light-guiding plate.

Japanese Unexamined Patent Application Publication No. 2012-163722 discloses a side back light of a liquid crystal display that includes a rectangular light-guiding plate and a light source that generates light incident on the side surfaces on first and second short sides of the light-guiding plate. The light-guiding plate irradiates the back face of the liquid crystal cell with the light from the light source. That is, the liquid crystal cell irradiated with light serves as a back light. For a uniform brightness of the back light, the light-guiding plate has a tilting surface that reduces the thickness of the light-guiding plate from the first and second short sides toward the center.

### SUMMARY OF THE INVENTION

An object of the present invention is to provide a readily visible display mechanism for a microphone and an accessory for a microphone that can clearly indicate the ON and OFF states of a switch with a limited number of light sources. Another object of the present invention is to avoid an increase in the number of required components and the overall dimensions and complexity of the structure and reduce material and production costs.

A microphone according to the present invention includes a switch that turns on and off an audio signal generated through acousto-electric conversion; a light source that is turned on and off in response to the operation of the switch; and a light radiator including a light-incident portion that receives light from the light source; a light guide that directs the incident light in the longitudinal direction of the light radiator; and a light diffuser that diffuses the light, the light guide having a thickness that decreases with the distance from the light-incident portion.

An accessory for a microphone according to the present invention includes a switch that turns on and off an audio signal generated through acousto-electric conversion; a light source that is turned on and off in response to the operation of the switch; a light radiator including a light-incident portion that receives light from the light source; a light guide that directs the incident light in a longitudinal direction of the light radiator; and a light diffuser that diffuses the light; and a microphone holder that holds the microphone therein, wherein, the light radiator is disposed around the microphone holder, and the light guide has a thickness that decreases with the distance from the incident portion.

The light from a light source transmitted to a light radiator through a light-incident portion is directed by a light guide in the longitudinal direction of the light radiator and is diffused from a light diffuser. The light guide of the light radiator has a thickness that decreases with the distance from the light-incident portion. Thus, the light converges in the light guide and is uniformly diffused from the light diffuser. The present invention can provide uniform light diffusion with a limited number of light sources, and thus can reduce material and production costs. Light can be uniformly diffused from the light diffuser with a thin light radiator, which can reduce the dimensions of the light radiator and the microphone.

### BRIEF DESCRIPTION OF DRAWINGS

FIG. 1 is a longitudinal cross-sectional view of a microphone according to an embodiment of the present invention.

FIG. 2 is a top plan view of the microphone.

FIG. 3 is a plan view of a light radiator in the microphone.

FIG. 4 is a front view of the light radiator.

FIG. 5 is a cross-sectional view taken along line A-A in FIG. 3.

FIG. 6 is a side view of the light radiator.

FIG. 7 is a back view of the light radiator.

FIG. 8 is an enlarged side view illustrating the relationship between the light radiator and light sources and the transmission of light.

FIG. 9 is a longitudinal cross-sectional view of an accessory for a microphone according to an embodiment of the present invention.

FIG. 10 is a longitudinal cross-sectional view illustrating a microphone installed in the accessory for a microphone according to an embodiment.

FIG. 11 is a longitudinal cross-sectional view illustrating the microphone installed in the accessory for a microphone according to an embodiment.

FIG. 12 is a top plan view of the accessory for a microphone.

FIG. 13 is a plan view of a light radiator according to another embodiment of the present invention.

FIG. 14 is a bottom view of the light radiator.

FIG. 15 is an enlarged bottom view of a light-incident portion of the light radiator.

FIG. 16 is a side view of the light radiator.

FIG. 17 is a back view of the light radiator.

FIG. 18 is a longitudinal cross-sectional view of a known microphone.

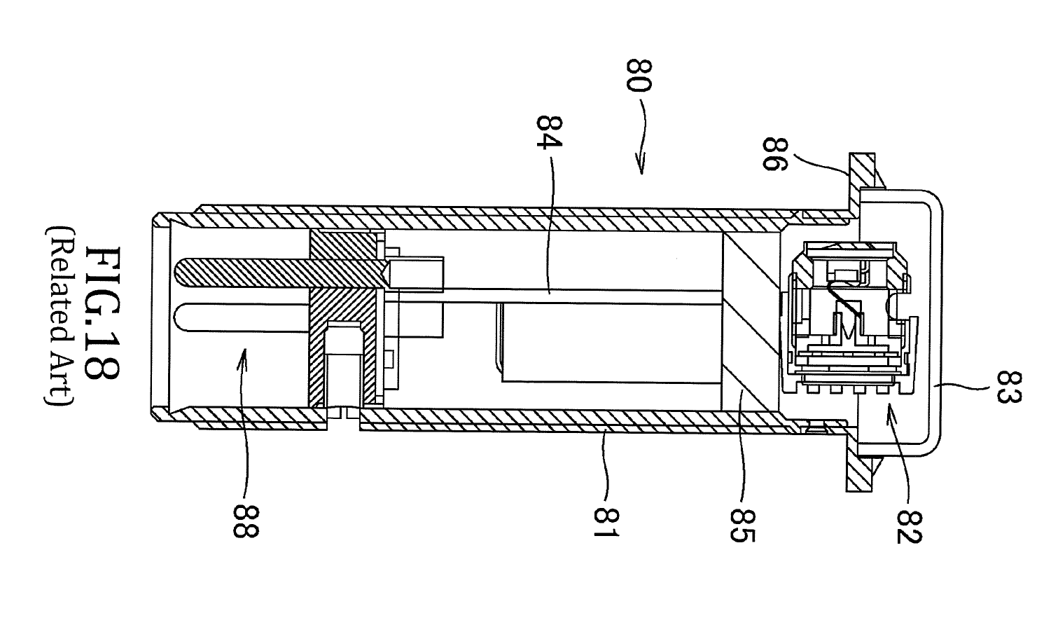

### DESCRIPTION OF THE PREFERRED EMBODIMENTS

A microphone and an accessory for the microphone according to embodiments of the present invention will now be described with reference to the accompanying drawings.

### First Embodiment

### Microphone

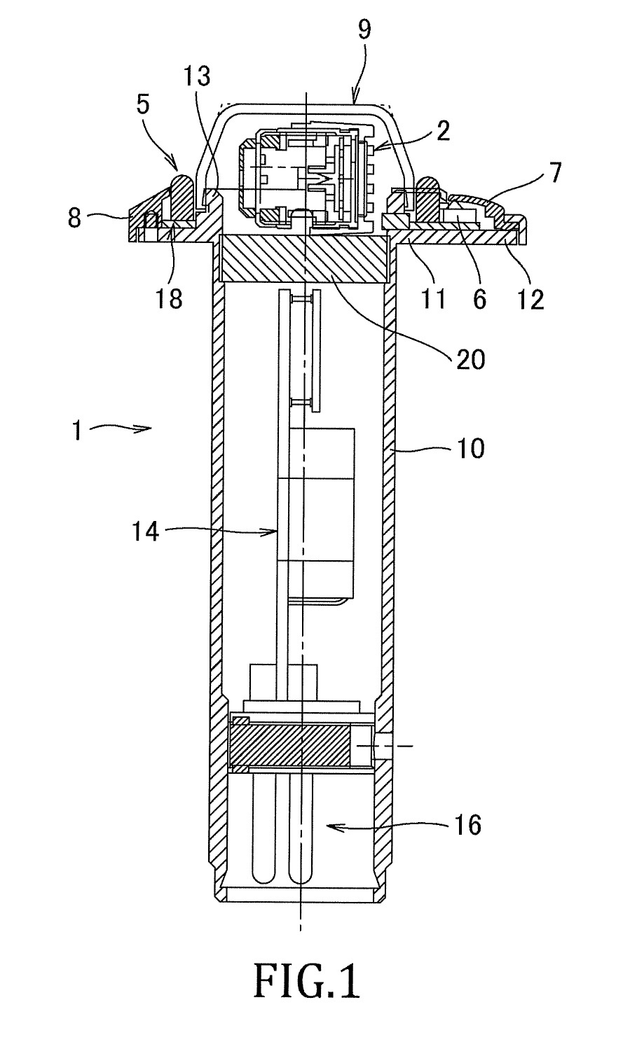

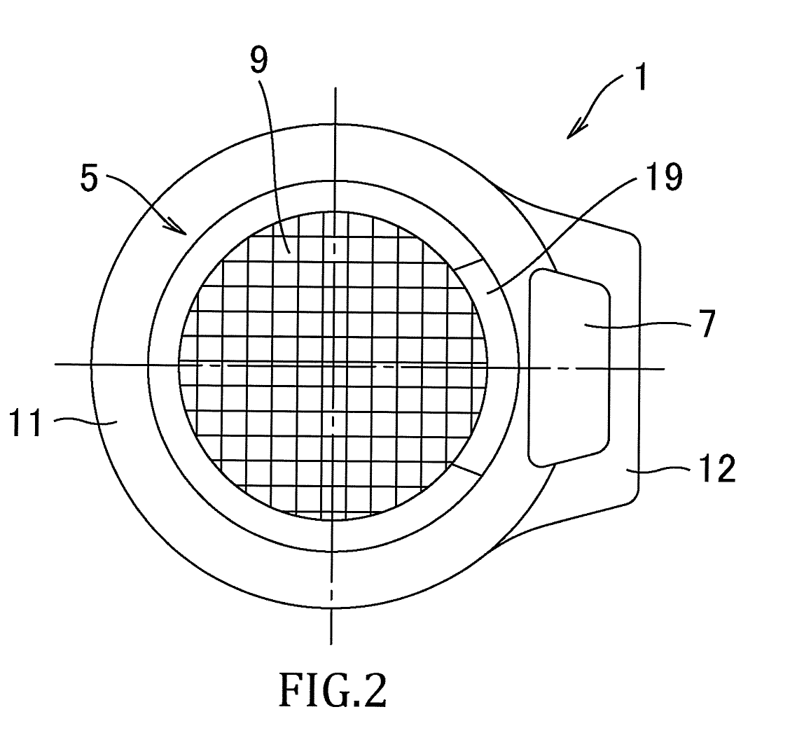

FIGS. 1 and 2 illustrate an embeddable boundary microphone according the first embodiment. The microphone 1 includes a cylindrical microphone body 10.

A cushioning 20 is fixed to the inner circumference of the upper portion of the microphone body 10. A microphone unit 2 is disposed on top of the cushioning 20. The microphone unit 2 may be of any acousto-electric conversion scheme. The illustrated embodiment is a condenser microphone unit. A microphone connector 16 that outputs audio signals to an external unit is attached to the lower portion of the microphone body 10. Hereinafter, the position where the microphone unit 2 is disposed on the microphone 1 will be referred to as the top of the microphone 1, and the position where the microphone connector 16 is disposed will be referred to as the bottom of the microphone 1. The microphone body 10 is composed of a conductive material.

A flange 11 is formed on the outer circumference of the top portion of the microphone body 10. A conductive ring 13 is disposed along the inner circumference of the top surface of the flange 11. The inner circumference of the bottom edge of a front mesh 9 fits the outer circumference of the top portion of the conductive ring 13.

The front mesh 9 is composed of a metal mesh bowl. The front mesh 9 is in the form of an inverted bowl. The lower edge of the front mesh 9 is an opening edge. The opening edge is bonded to the conductive ring 13. The conductive ring 13 is disposed between the front mesh 9 and the microphone body 10. The conductive ring 13 electrically connects the front mesh 9 and the microphone body 10.

The front mesh 9 surrounds the microphone unit 2 with a predetermined gap therebetween. The front mesh 9 transmits sound waves. An annular circuit board 18 adjoining the outer circumference of the conductive ring 13 is bonded to the upper surface of the flange 11.

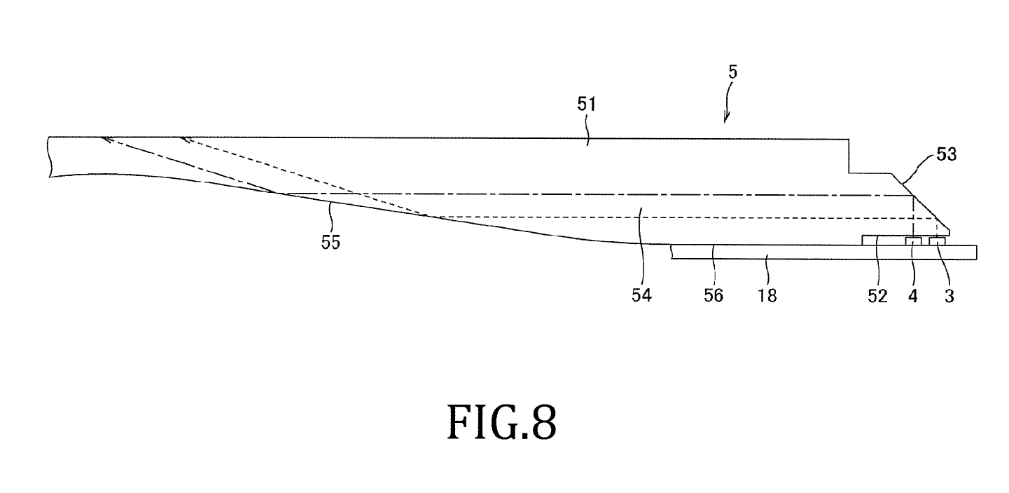

With reference to FIG. 8, the circuit board 18 includes light-emitting elements 3 and 4. A light radiator 5 is disposed above the light-emitting elements 3 and 4 on the circuit board 18. The light radiator 5 is substantially annular and surrounds the front mesh 9, which functions as an audio entrance to the microphone unit 2. The light radiator 5 will now be described in detail.

### [Configuration of Light Radiator]

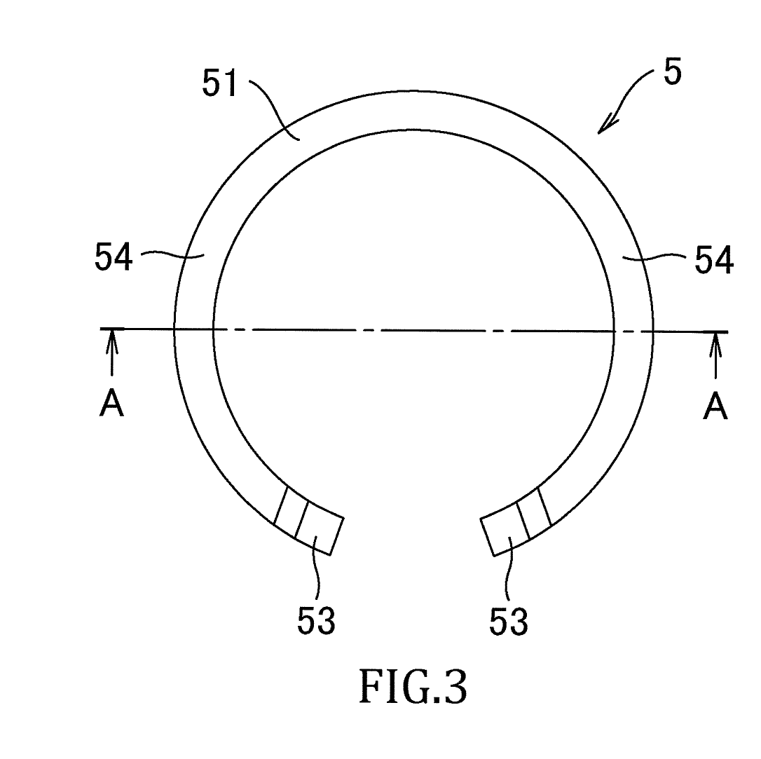

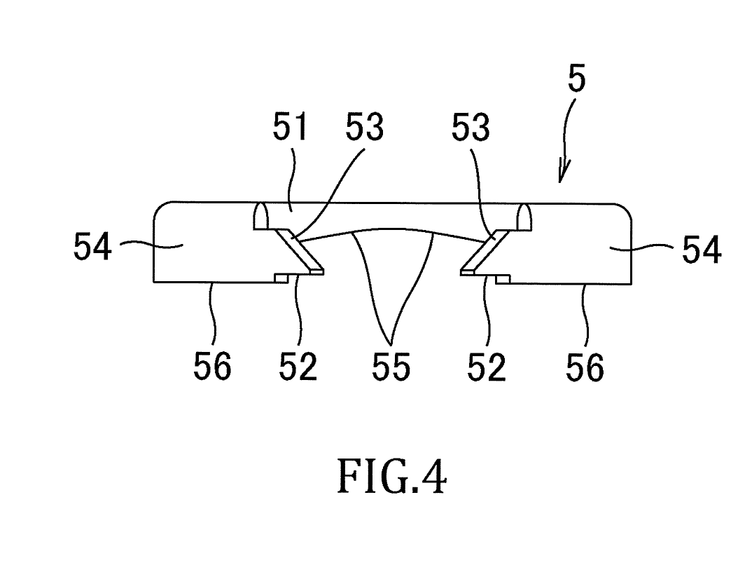

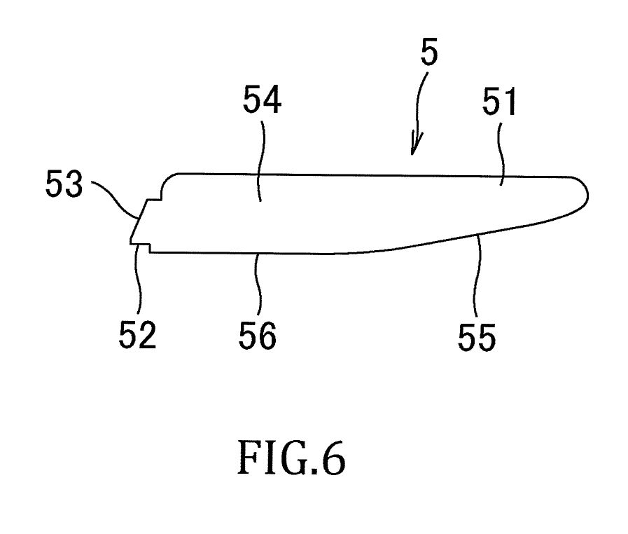

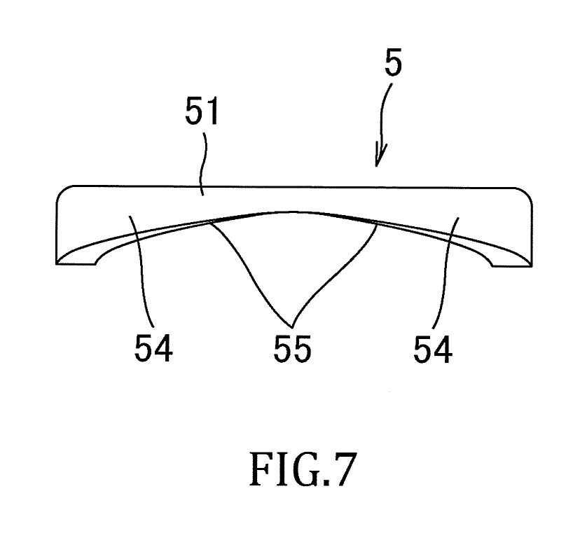

With reference to FIGS. 3 to 8, the light radiator 5 is substantially annular and extends along the outer circumference of the front mesh 9 in the longitudinal direction. The annular light radiator 5 is partially cut away such that the light radiator 5 is substantially C-shaped in plan view. In this embodiment, the light radiator 5 is composed of a single acrylic molded product. The bottom side of the light radiator 5 is flanged at the ends in the longitudinal direction to form light-incident portions 52. The light radiator 5 has flat bottom surfaces 56 that extend for predetermined distances from the ends in the longitudinal direction. The light-incident portions 52 are parallel to the bottom surfaces 56. The light-incident portions 52 have a mirror finish.

With reference to FIG. 8, the bottom surfaces 56 of the light radiator 5 are in contact with the upper surface of the circuit board 18. Multiple light-emitting elements (two light-emitting elements 3 and 4 in this embodiment) are disposed on the circuit board 18 at positions facing the light-incident portions 52. The light-emitting elements 3 and 4 are mounted on the circuit board 18 with their light-emitting surfaces facing upward. In this embodiment, the light-emitting element 3 is a green light-emitting diode (LED) and the light-emitting element 4 is red LED.

The light radiator 5 has two ends in the longitudinal direction with reflective surfaces 53 tilted by approximately 45 degrees above the light-incident portions 52. The reflective surfaces 53 are mirror-finished. Each of the reflective surfaces 53 tilts in a direction that reflects the light from the light-emitting elements 3 and 4 toward the interior of the light radiator 5. The mirror finishing of the reflective surfaces 53 may be achieved with reflective stickers bonded thereon, for example.

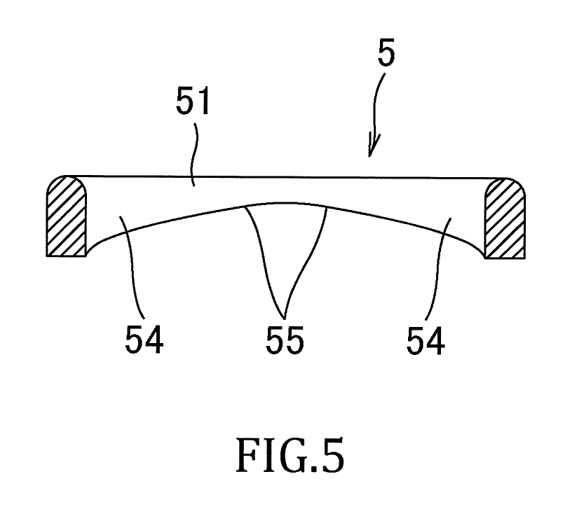

With reference to the cross-sectional view in FIG. 5, the light radiator 5 has a semicircular top surface. The semicircular top surface is blast-finished and serves as a light diffuser 51. The bottom surface of the light radiator 5 may be mirror-finished or may be provided with a reflective film so as to achieve total reflection of the light reflected at the reflective surfaces 53. The light radiator 5 is composed of a material that functions as a light guide 54. The light radiator 5 is composed of transmissive resin, which may be mixed with a light-diffusing agent. The light radiator 5 composed of a material containing a light-diffusing agent can uniformly transmit the light from the light-emitting elements 3 and 4 throughout the light guides 54. The light diffuser 51 of the light radiator 5 composed of a material mixed with a light-diffusing agent may be blast-finished.

The light from the light-emitting elements 3 and 4 enters the light radiator 5 through the light-incident portions 52 at both ends of the light radiator 5. The light guided into the light radiator 5 is reflected at the reflective surfaces 53 to the interior of the light radiator 5. The reflected light is diffused at the upper surface or light-diffusing surface of the light radiator 5, reflected at the bottom surface, and transmitted through the light guides 54. The reflected light transmitted through the light radiator 5 is diffused from the light diffuser 51, which has a semicircular cross-section. The light diffuser 51 extends along the entire length of the light radiator 5. The light-emitting element 3 or 4 illuminates the entire light diffuser 51.

For example, the light-emitting element 3 is a green LED, and the light-emitting element 4 is a red LED. The light-emitting element 3 illuminates the entire light diffuser 51, which is the upper surface of the light radiator 5, with green light. The light-emitting element 4 illuminates the entire light diffuser 51 with red light.

As described above, the bottom of the light radiator 5 has the flat bottom surfaces 56 with predetermined lengths from the ends in the longitudinal direction. The bottom of the light radiator 5 has tilting surfaces 55 that define an arch such that the thickness of the light radiator 5 gradually decreases with the distance from the bottom surfaces 56. In general, as the distance increases from the light-emitting elements 3 and 4, the intensity of the light decreases. The light radiator 5 according to the first embodiment has the tilting surfaces 55 on the bottom. The tilting surfaces 55 of the light radiator 5 have a thickness that decreases with the distance from the light-emitting elements 3 and 4, and this structure causes light to converge.

The light radiator 5 having such a structure transmits light for a long distance and causes the light to converge to compensate for a decrease in the intensity of light as the distance increases from the light-emitting elements 3 and 4. In this way, the light radiator 5 radiates light having uniform intensity. The tilting surfaces 55 defining an arch may alternatively define an inverted V-shape for the same advantages.

The microphone 1 turns on the light-emitting element 3 when an audio signal is output to illuminate the light radiator 5 with green light, and turns on the light-emitting element 4 when an audio signal is not output to illuminate the light radiator 5 with red light. The microphone 1 varies the illuminating state of the light-emitting elements 3 and 4 to indicate its operating state. One or more light-emitting elements may be provided. One light-emitting element can indicate two operating states of the microphone 1: turning-on of the light-emitting element indicates an operating state of the microphone 1 whereas turning-off of the light-emitting element indicates a non-operating state of the microphone 1.

With reference to FIGS. 1 and 2, the flange 11 of the microphone body 10 has a protrusion 12 protruding outward in the radial direction. A switch 6 is disposed on the upper surface of the protrusion 12. An operating plate 7 covers the upper side of the switch 6. The operating plate 7 is in contact with the operating button of the switch 6. Thus, the pressing of the operating plate 7 pushes the operating button down and switches the switch 6 between ON and OFF states.

The operation of the switch 6 alternates the power supply between the light-emitting elements 3 and 4 and causes the color of the generated light to alternate between green and red. Consequently, the color of the light emitted from the light radiator 5 also alternates between green and red. Alternatively, the operation of the switch 6 may turn on and off the light-emitting elements. That is, turning on/off of an output signal from the microphone 1 in response to the operation of the switch 6 switches the operation of the light-emitting elements.

A cover 8 covers the outer circumferential area of the flange 11 of the microphone body 10. The cover 8 has a cylindrical section that fits the outer circumference of the flange 11 and a conical section connecting to the cylindrical section. The inner circumferential edge of the upper portion of the conical section fits the outer circumference of the upper portion of the light radiator 5. The upper portion of the light radiator 5 is exposed between the inner circumferential edge of the cover 8 and the outer circumference of the front mesh 9.

The cover 8 is integrated with a pad 19 (see FIG. 2) that covers the cut-away part of the light radiator 5, which is C-shaped in plan view. Part of the conical section of the pad 19 protrudes inward. The pad 19 extends in the circumferential direction into an arch and has flat top and bottom surfaces.

The microphone body 10, which is a major portion of the boundary microphone, is embedded in a top panel, such as a tabletop. The flange 11 of the microphone body 10 is fixed to the top panel with a cushioning disposed therebetween. The front mesh 9, the cover 8, and the light radiator 5 are exposed on the top panel. Sound waves that transmit through the front mesh 9 enter the microphone unit 2 and then are acousto-electrically converted therein. The color of the illumination of the light radiator 5 indicates the state of the microphone 1: an output mode of audio signals or a stand-by mode. A circuit board 14 having a microphone circuit is fixed in the interior of the microphone body 10.

The ON and OFF states of the microphone according to this embodiment can be indicated by the light from the light radiator 5. The thickness of the light guides 54 of the light radiator 5 according to this embodiment decreases with the distance from the light-incident portions 52. This structure causes light to converge along the light guides 54 and to uniformly diffuse from the light diffusers 51.

The structure according to this embodiment can provide uniform light diffusion with a limited number of light sources, and thus can reduce material and production costs. According to this embodiment, light is uniformly diffused from the light diffuser 51 with a thin light radiator 5, which can reduce the dimensions of the light radiator 5 and the microphone. For these reasons, the structure of the light radiator and the assembly structure of the light radiator and the peripheral light sources can be simplified in this embodiment. This facilitates the assembly and maintenance and reduces the risk of the defects.

### [Modification 1 of Microphone]

The light guides 54 of the light radiator 5 according to this embodiment have tilting surfaces 55 defining an arch such that the thickness of the light guides 54 gradually decreases with the distance from the light-incident portions 52 at both ends. The tilting surfaces 55 are separated from the upper surface of the circuit board 18, which is the mounting surface of the light radiator 5. If load is applied to the separated portion from above, the light radiator 5 bends. Specifically, the thinnest portion receives the most stress and bends most significantly. Therefore, application of load may cause this portion to break.

A pad is disposed in the space between the tilting surfaces 55 and the upper surface of the circuit board 18, which is the support of the light radiator 5, to prevent bending of the light radiator 5 due to an external force. The pad may be a columnar member that is disposed between the thinnest portion of the light radiator 5 and the upper surface of the circuit board 18. The pad is preferably composed of a material that has a refractive index smaller than that of the light radiator 5. A pad composed of such a material can enhance the reflection of the tilting surfaces 55.

### [Modification 2 of Microphone]

An embeddable boundary microphone is described in the above embodiment. The microphone according to the present invention should not be limited to the embodiment described above. For example, the present invention may be applied to flat boundary microphones that are disposed on top panels, such as table tops, or gooseneck microphones.

A gooseneck microphone according to the present invention may include a light radiator surrounding a microphone body attached to the tip of a flexible cable. Another gooseneck microphone according to the present invention may include a light radiator surrounding the base portion of a microphone in connection with the base end of a flexible cable. The present invention may also be applied to microphones for karaoke machines, for example. A microphone for a karaoke machine may include a light radiator surrounding a predetermined area, such as an audio entrance, of the microphone body.

### Second Embodiment

### Accessory for Microphone

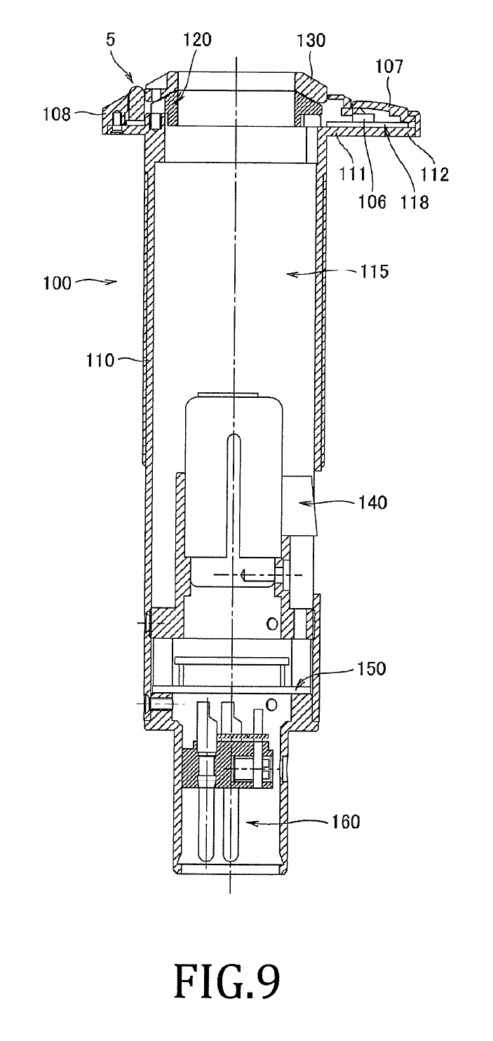

An accessory for a microphone according to the second embodiment will now be described. A microphone holder 100, which is an accessory for a microphone according to the second embodiment, is illustrated in FIGS. 9 to 12. The microphone holder 100 has a cylindrical microphone holding portion 110.

The internal space of the microphone holding portion 110 functions as a microphone attachment 115. A connector 140 fittable with the connector of a microphone is disposed in the lower portion of the interior of the microphone holding portion 110. A circuit board 150 is disposed below the connector 140, and a connector 160 couplable with a microphone cable is disposed below the circuit board 150. The audio signals generated by the microphone are output to an external device via the connectors 140 and 160.

The outer circumference of the upper edge of the microphone holding portion 110 is integrated with a flange 111. An annular circuit board 118 is bonded to the upper surface of the flange 111. Light-emitting elements are mounted on the circuit board 118, like the circuit board 18. A light radiator 5 is disposed above the circuit board 118 with the light-emitting elements disposed therebetween. The light radiator 5 has the same configuration as that of the light radiator 5 according to the first embodiment. Components that are the same as those in the light radiator 5 according to the first embodiment are denoted by the same reference numbers. With reference to FIGS. 3 to 8, the light radiator 5 has a light diffuser 51, light-entering portions 52, reflective surfaces 53, light guides 54, tilting surfaces 55, and bottom surfaces 56.

The flange 111 has a protrusion 112, which partly protrudes radially outward. A switch 106 is disposed on the upper surface of the protrusion 112 of the flange 111. An operating plate 107 covers the top of the switch 106. The operating plate 107 is in contact with the operating button of the switch 106. Thus, the pressing of the operating plate 107 pushes the operating button down and turns on or off the switch 106.

A shock mount 120 that holds the microphone in the microphone attachment 115 is disposed at the upper end of the microphone holding portion 110, and a rock ring 130 is disposed above the shock mount 120. The shock mount 120 and the rock ring 130 are in the form of rings that surround the microphone or the base portion of the microphone disposed in the microphone attachment 115.

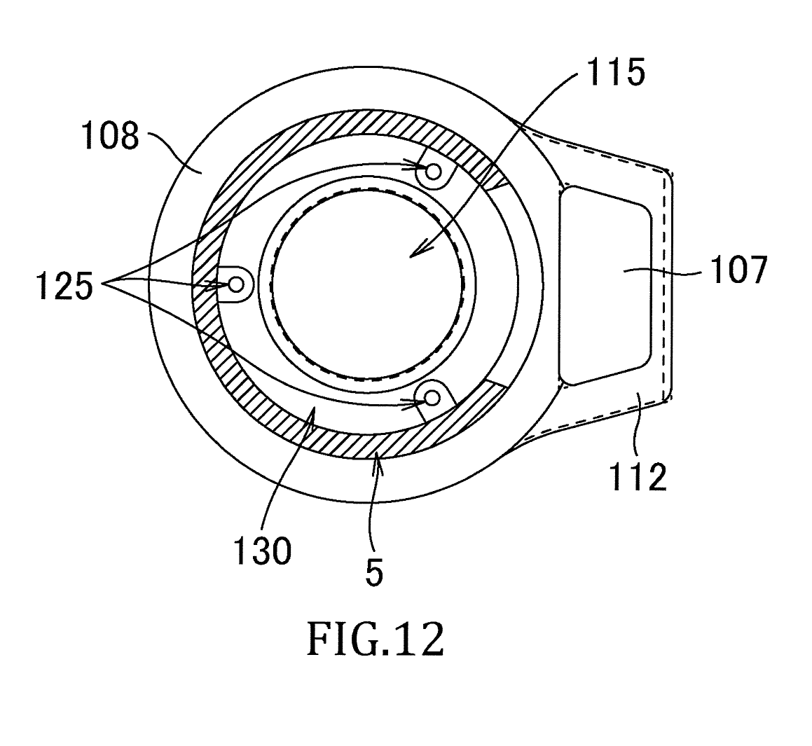

The shock mount 120 is composed of an elastic material, e.g., rubber, which deforms by compression or tension. With reference to FIG. 12, the rock ring 130 is composed of a rigid material, such as metal, and has multiple (three, in the drawing) tapped holes 125 at predetermined positions on the circumference. Screws are engaged with the tapped holes 125. Tightening the screws into the microphone holding portion 110 from above causes the rock ring 130 to compress the shock mount 120.

The procedure for attachment of the microphone to the microphone holder 100 and the operation during the attachment will now be described. The microphone holder 100 illustrated in the drawing serves as an accessory for holding a gooseneck microphone 200 at the base portion 210 of the gooseneck microphone 200.

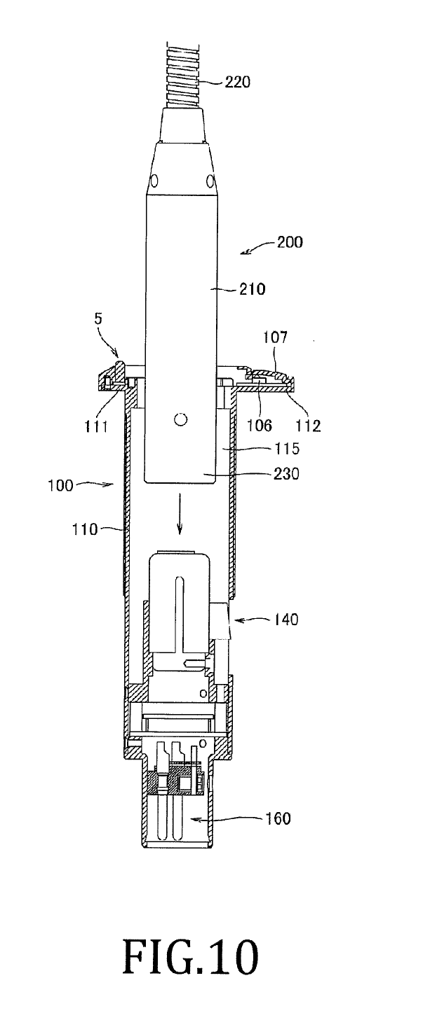

The base portion 210 of the gooseneck microphone 200 is disposed in the microphone attachment 115 of this accessory, as shown in FIG. 10. A base end of a flexible pipe 220 is attached to the upper end of the base portion 210 of the gooseneck microphone 200. A microphone (not shown) is attached to the distal end of the flexible pipe 220. The shock mount 120 and the rock ring 130 are not shown in FIG. 10.

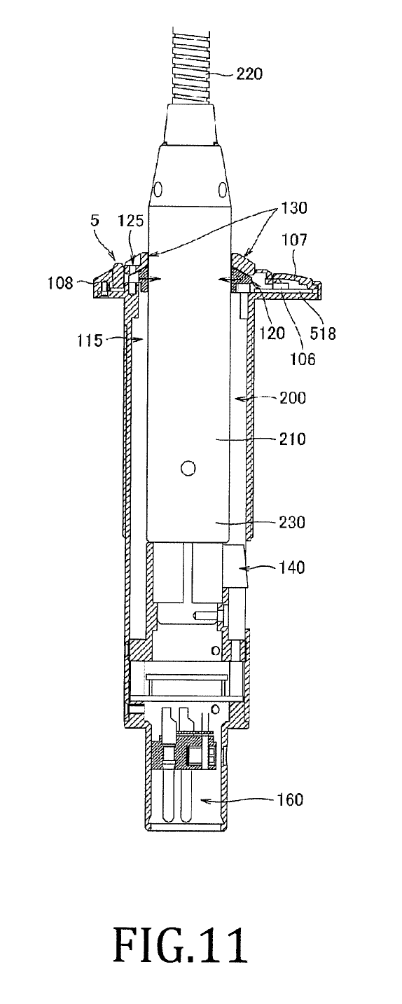

The base portion 210 of the gooseneck microphone 200 is disposed in the microphone attachment 115. A connector disposed at the bottom end of the base portion 210 is connected with the connector 140 of the microphone holder 100, as illustrated in FIG. 11. Screws are inserted into the tapped holes 125 of the rock ring 130. The screws inserted into the tapped holes 125 are tightened into the microphone holding portion 110. The rock ring 130 compresses the shock mount 120. The shock mount 120 receives the pressure and deforms so as to reduce the inner diameter and urges the outer circumference of the base portion 210 of the gooseneck microphone 200.

This fixes the base portion 210 of the gooseneck microphone 200 to the microphone attachment 115. The elastic shock mount 120 serves as a buffer for the base portion 210 and reduces the transmission of the vibration of the microphone holder 100 to the gooseneck microphone 200.

In the accessory for a microphone, the pressing of the operating plate 107 pushes the operating button of the switch 106 down to turn on or off the switch 106. Every time the switch 106 is operated, the electrical supply is switched between the light-emitting elements mounted on the circuit board 118. This switches the color of the light emitted from the light-emitting elements between red and green, for example. Consequently, the color of the light from the light radiator 5 also varies to the same color as the light from the light-emitting elements. Alternatively, the light-emitting elements of the accessory for a microphone may be turned on or off through the operation of the switch 106. That is, turning on or off the output signal of the microphone through the operation of the switch 106 of the accessory for a microphone switches the operating state of the light-emitting elements.

According to the accessory for a microphone described above, the ON and OFF states of the gooseneck microphone 200 can be indicated through the difference in the state of the light emitted from the light radiator 5.

The light radiator 5 according to this embodiment has the same configuration as the light radiator 5 according to the first embodiment. That is, the convergence of light is enhanced as the length increases from the light-entering portions 52, and the light is uniformly diffused from the light diffuser 51. The light radiator 5 can provide uniform light diffusion with a limited number of light sources, and thus can reduce material and production costs. Light is uniformly diffused from the light diffuser 51 with a thin light radiator 5, which can reduce the dimensions of the light radiator 5 and the microphone. For these reasons, the structure of the light radiator and the assembly structure of the light radiator and the peripheral light sources can be simplified in this embodiment. This facilitates the assembly and maintenance and reduces the risk of the defects.

Similar to the first embodiment, a pad may be disposed in the gap between the tilting surfaces 55 and the circuit board 518 of the light radiator 5 according to this embodiment.

### [Modification of Light Radiator]

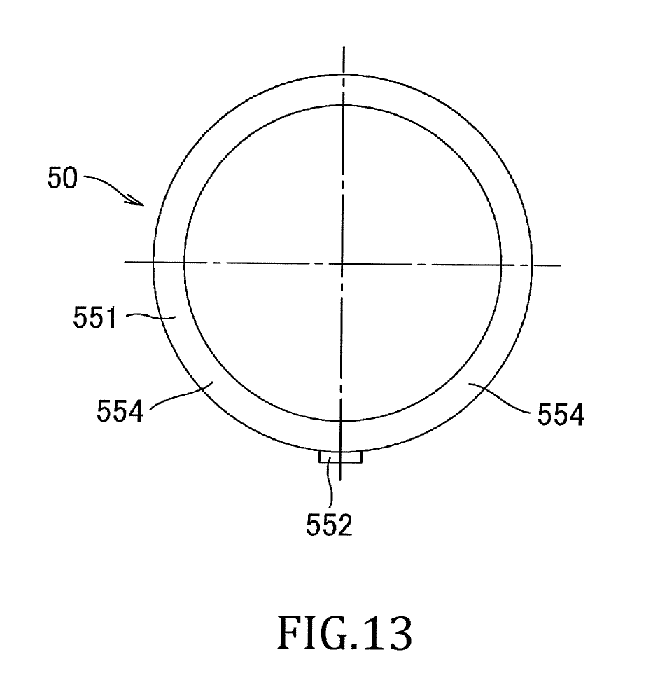

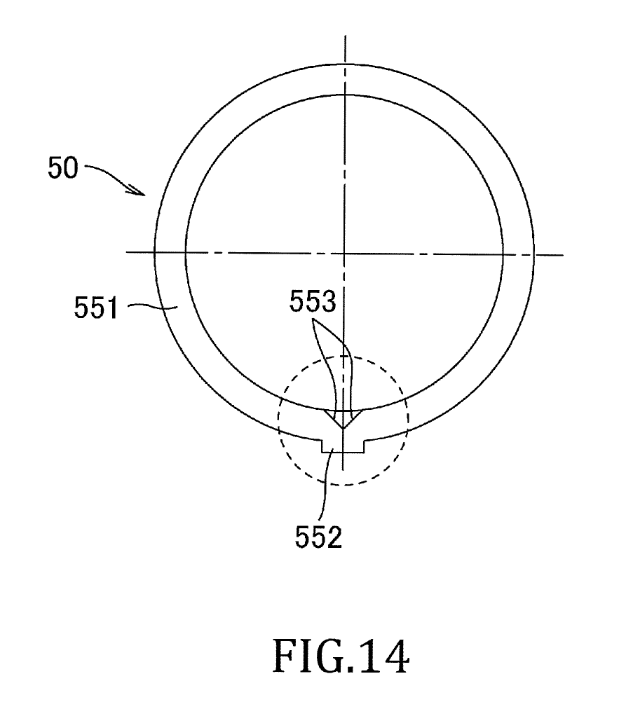

The light radiator according to the embodiments described above is partially cut away to form a C-shape in plan view. Alternatively, the light radiator may be in the form of a complete ring, as illustrated in FIGS. 13 to 17.

With reference to FIGS. 13 to 17, a light radiator 50 is in the form of a ring in plan view. Part of the outer circumference of the light radiator 50 protrudes radially outward to define a light-incident portion 552. The protruding end of the light-incident portion 552 is a flat surface. Light from a light source facing the flat surface is incident on the flat surface. The upper half of the light radiator 50 in the thickness direction is in the form of a semicircle in a longitudinal cross-sectional view. The upper surface of the semicircular cross-section of the light radiator 50 is blast-finished and serves as a light diffuser 551.

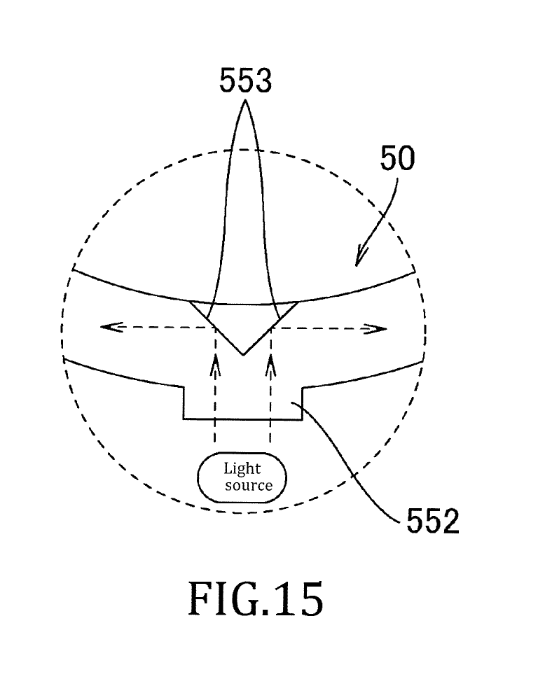

With reference to FIG. 15, the light radiator 50 has two reflective surfaces 553 on the inner circumference of the light-incident portion 552. The reflective surfaces 553 reflect light from the light-incident portion 552 in the longitudinal or circumferential direction of the light radiator 50.

The two reflective surfaces 553 reflect the incident light in opposite directions. The reflective surfaces 553 are formed by mirror finishing.

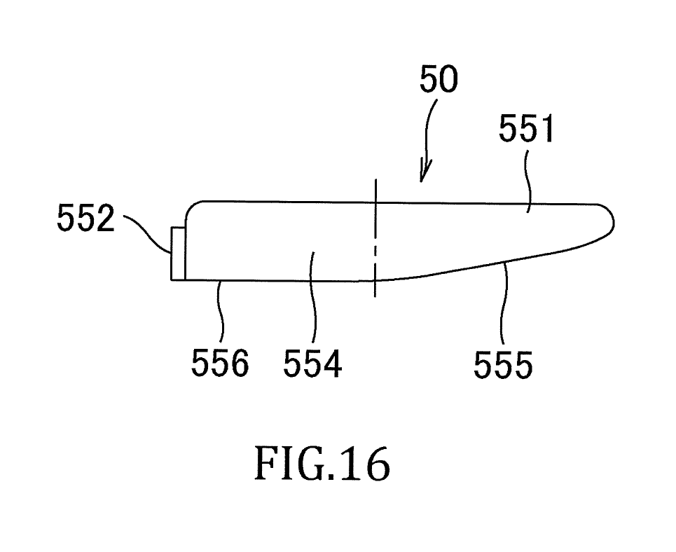

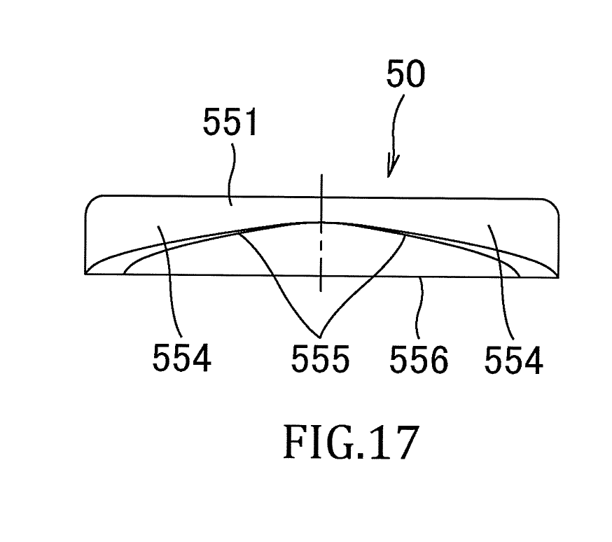

With reference to FIGS. 16 and 17, the bottom of the light radiator 50 has a flat bottom surface 556 that extends in the opposite directions for predetermined length from the light-incident portion 552. The bottom of the light radiator 50 farther from the light-incident portion 552 than the bottom surface 556 has tilting surfaces 555. The thickness at the tilting surfaces 555 decreases with the distant from the light-incident portion 552. The light radiator 50 is the thinnest at a position 180 degrees from the light-incident portion 552 along the circumference. Annular light guides 554 extend from the light-incident portion 552 of the light radiator 50 along the bottom surface 556.

The light-incident portion 552 of the light radiator 50 illustrated in FIGS. 13 to 17 is the thinnest at the position farthest from the light-incident portion 552. Thus, the convergence of light is the greatest at the position farthest from the light-incident portion 552. In the light radiator 50, the convergence of light is enhanced with the distance from the light-incident portion 552, and the light is uniformly diffused from the light diffuser 551. The light radiator 50 can provide uniform light diffusion with a limited number of light sources, and thus can reduce material and production costs. In the light radiator 50, light is uniformly diffused from the light diffuser 551 with a thin light radiator 50, which can reduce the dimensions of the microphone.

### [Another Modification of Light Radiator]

The light incident on both ends of the light radiator described above or the middle area along the longitudinal direction of the light radiator is guided along the longitudinal direction of the light radiator in opposite directions. One of the ends of the light radiator may have a light-incident portion. Uniform diffusion of light along the entire longitudinal direction of the light radiator according to this modification is achieved by the thinnest portion of the light radiator at a position farthest from the light-incident portion, i.e., the other end of the light radiator.

The light-incident portion may be disposed at the middle area of the longitudinal direction of the light radiator so as to reflect the light incident on the light radiator in opposite directions. The light radiator having such a structure is thinnest at both ends farthest from the light-incident portion.

The shape of the light radiator should not be limited to a ring. For example, the light radiator may be shaped as an ellipsoidal or a linear structure.

The light is incident on the light radiator according to this embodiment at a direction orthogonal to the longitudinal direction of the light radiator, as shown in the drawings. The light radiator has a reflective surface that guides the light from a light source along the longitudinal direction of the light radiator. The light radiator having such a structure can guide the light from a light source mounted on a circuit board, for example, into the light radiator.

The light radiator may have any other configuration. For example, the light radiator may have a light source facing an end surface of the light radiator such that the light is directly guided through the light radiator in the longitudinal direction. The light radiator having such a structure does not require a reflective surface for changing the direction of the propagating light.

The light radiator may include a phosphorescent or fluorescent component (hereinafter merely referred to as phosphorescent component). A phosphorescent component, for example, is disposed along a side surface of the light radiator. The light from the light source is incident on the phosphorescent component and is absorbed in the phosphorescent component. A light radiator having such a structure has phosphorescent characteristics. That is, it absorbs light while a light-emitting element is being turned on and radiates the absorbed light while the light-emitting element is being turned off.

Such a light radiator has a light-emitting element that emits light while the microphone is being turned off and does not emit light while the microphone is being turned on. While the microphone is being turned off, the light-emitting element emits light that is absorbed by the phosphorescent component of the light radiator, and then, the light radiator emits colored light from the light-emitting element.

Upon turning-on of the microphone, the light-emitting element is turned off, and the phosphorescent component of the light radiator emits the absorbed light. The light emitted from the phosphorescent component is controlled such that its color is different from the color of the light emitted from the light-emitting element. The ON and OFF states of the microphone can be clearly indicated by a single light-emitting element. This structure is advantageously used in dark environments, such as in a meeting that uses a slide projector or video projector.

What is claimed is:

1. A microphone comprising:
a switch that turns on and off an audio signal generated through acousto-electric conversion;
a light source that is turned on and off in response to the operation of the switch; and
a light radiator comprising:
at least one light-incident portion that receives light from the light source;
a light guide that directs the incident light in a longitudinal direction of the light radiator; and
a light diffuser that diffuses the light,
the light guide having a thickness that decreases with distance from the light-incident portion.

2. The microphone according to claim 1, further comprising a boundary microphone, and wherein
the light radiator comprises an annular member that surrounds an audio entrance of the boundary microphone.

3. The microphone according to claim 2, wherein the boundary microphone is an embeddable boundary microphone.

4. The microphone according to claim 1, further comprising a gooseneck microphone, and wherein
the light radiator comprises an annular member that surrounds the gooseneck microphone.

5. The microphone according to claim 1, wherein,
the at least one light-incident portion comprises two light-incident portions that are disposed at both ends of the light guide along the longitudinal direction, and
the light guide is the thinnest at a middle area along the longitudinal direction.

6. The microphone according to claim 1, wherein the light-incident portion is disposed at a middle area of the light guide along the longitudinal direction.

7. The microphone according to claim 1, wherein the light radiator has a C-shape.

8. The microphone according to claim 1, wherein,
the light radiator has an annular shape, and
the light-incident portion is disposed on a portion of the annular light radiator and is the thinnest at a position 180 degrees from the light-incident portion along the circumference.

9. The microphone according to claim 1, wherein the light source comprises at least one light-emitting element.

10. The microphone according to claim 1, wherein,
the light source comprises a plurality of light-emitting elements emitting different light colors, and
the light-emitting elements emitting different light colors are turned on in response to the ON and OFF operation of the switch.

11. The microphone according to claim 10, wherein the at least one light incident portion includes a light incident portion for each of the light-emitting elements emitting different light colors, and wherein each of the light-emitting elements are disposed in respective light-incident portions.

12. The microphone according to claim 1, further comprising:
a support that supports the light radiator; and
a pad that is disposed in a gap between the light radiator and the support.

13. The microphone according to claim 12, wherein the refractive index of the pad is smaller than the refractive index of the light radiator.

14. An accessory for a microphone, comprising:
a switch that turns on and off an audio signal generated through acousto-electric conversion;
a light source that is turned on and off in response to the operation of the switch;
a light radiator comprising:
a light-incident portion that receives light from the light source;
a light guide that directs the incident light in a longitudinal direction of the light radiator; and
a light diffuser that diffuses the light; and
a microphone holder that holds the microphone therein,
wherein,
the light radiator is disposed around the microphone holder, and
the light guide has a thickness that decreases with distance from the light-incident portion.

15. The accessory for a microphone according to claim 14, wherein the microphone holder comprises:
a connector that fits a connector on the microphone and outputs the audio signal to an external unit.

16. The accessory for a microphone according to claim 14, wherein the microphone holder comprises a cylinder having a flange on a distal end and is embeddable into a tabletop below the flange.

17. The accessory of a microphone according to claim 16, wherein the light radiator is disposed on the flange.

18. The accessory of a microphone according to claim 14, wherein the microphone holder accommodates a base portion of a gooseneck microphone to hold the gooseneck microphone.
